(19) United States
(12) Patent Application Publication
(10) Pub. No.: US 2002/0052757 A1
(43) Pub. Date: May 2, 2002

(54) Network data sharing system

(76) Inventor: Thomas S. Lewis, Evanston, IL (US)

Correspondence Address: Beck & Tysver, P.L.L.C., Suite 100, 2900 Thomas Avenue South, Minneapolis, MN, 55416-4477, US

(21) Appl. No.: 10/016,714

(22) Filed: Oct. 22, 2001

Related U.S. Application Data
(60) Provisional application No. 60/243,706, filed on Oct. 27, 2000.
(60) Provisional application No. 60/246,823, filed on Nov. 8, 2000.

(51) Int. Cl. G06F 17/60; G06F 15/00

(52) U.S. Cl. 705/1; 707/513

(57) ABSTRACT

A method and system for aggregating and delivering data of competing enterprises via the Internet. Data items are created or entered at a variety of participating client systems. The data from the participating client systems are then received by the server system and aggregated to form a single data collection. The server then sends to each client system HTML data that contains a portion of the aggregated data as well as a search and selection functions that allows searching and selecting across the aggregated data. Each client system receives the HTML data and displays the data to users of their own web site. The HTML data is either shown as a separate frame forming a part of the client system's web site, or is otherwise integrated into an HTML page created by the client system. It is possible to remove information in the aggregated data so as to limit the end users ability to use the data without assistance from the participating clients.

### CROSS-REFERENCE TO A RELATED APPLICATION

This application claims the benefit of U.S. Provisional Application No. 60/243,706, filed Oct. 27, 2000, and U.S. Provisional Application No. 60/246,823, filed Nov. 8, 2000.

### FIELD OF THE INVENTION

The present invention relates to sharing data among competitive businesses over a computer network. More specifically, the present invention is a method and system for competing businesses to share data, aggregate the shared data, and to deliver the aggregated data through a networked data sharing system.

### BACKGROUND OF THE INVENTION

The Internet comprises a vast number of computers and computer networks that are interconnected through communication links. The interconnected computers exchange information using various services, such as electronic mail, Gopher and the World Wide Web (the “web”). The web service allows a server computer system to send graphical web pages of information to a remote client computer system, which receives and displays the web pages through a browser software program. Web pages are specified by a Uniform Resource Locator (“URL”), and are transferred to the browser software through the Hypertext Transfer Protocol (or “HTTP”). Web pages are defined using Hypertext Markup Language (or “HTML”), which provides a standard set of tags that define how a web page is to be displayed.

The web is especially conducive to electronic commerce. Many web servers have been developed through which vendors can market and sell products. The products can include data items (e.g., music, video, or text) that are delivered electronically over the Internet, and physical items (e.g., books, cars, or appliances) that are delivered through conventional distribution channels. An e-commerce web server may also provide a catalog that lists the items that are available through that server. Such a catalog allows the consumer to browse through all of the available items before selecting the items that she wishes to purchase.

The selection of various items from electronic catalogs is generally based on the “window shopping” model. When the consumer views an item from the electronic catalog, the e-commerce server displays what is available from that retailer, but not items that are available from other retailers. Such an ordering model can be problematic for a couple of reasons. For example, if a consumer wishes to review all of the products available from all e-commerce sites, then the effort to separately search and review the necessary sites can be overwhelming. In addition, because of the time required to perform such multiple searches, it is possible that new items will be added to the first site searched before all of the other possible sites are searched. As a result, the consumer cannot be assured that they have reviewed all of the possible options before making a decision.

This problem is especially severe when the items being reviewed are large ticket, singularly unique items such as real estate or used car listings. Real estate listings, for instance, are generally controlled by real estate agencies. A person who wishes to review all of the real estate listings in a particular locality traditionally has had to search each of the web sites of the real estate agencies serving that location. Similarly, used car listings were traditionally searched by searching on the web servers of each of the car dealerships in a geographic area that might sell used cars.

To overcome this inefficiency, web sites have been developed that aggregate data from numerous parties so that customers can search a single site to find objects available at competing agencies, dealerships, or retailers. Generally, these sites function through an agreement with each of the competing businesses. The businesses agree to share their data with the aggregating web site, figuring that the additional exposure of their products or listings will increase the likelihood of sales. An example of an aggregating web site can be found at www.realtor.com.

Unfortunately, the sharing of such data with aggregating web sites leads to a loss of web traffic at the web sites of the participating businesses. The web traffic could be lost through decreased use of the site as a point of entry site, or through a decrease in the duration of visits or the number of repeat users. This is because end users no longer feel the need to use a single company's web site, since all of the listings or products from that company can be found at the aggregated web site.

The loss of web traffic can have a direct financial impact on these businesses. For instance, if the web traffic could be kept on the business' proprietary web site, the business could improve its name recognition with the consuming public. This problem is only partially offset by the known practice of branding an aggregating web site by placing a logo of a referring business on the page of the aggregating web site. An example of this practice is currently seen at the www.cars.com aggregating web site when accessed through the web site of one of its participating businesses, such as the www.startribune.com web site. While such branding is helpful, the referring business has no control over the overall look and feel of the aggregating web site.

In addition, and perhaps more importantly, the loss of web traffic limits the ability of the participating businesses to obtain revenue through the sale of secondary services and goods. For example, a real estate agency's web site could advertise the mortgage services, moving services, or relocation services of affiliated or partnered service companies. In exchange for a referral of some sort, these companies may be willing to pay a referral fee or otherwise compensate the referring real estate agency. However, with the transfer of web traffic from the proprietary web site of the agency to the site of the data aggregator, the agency is less able to recommend these services and receive these referral fees.

Some competing businesses have realized the above difficulties, and have entered into arrangements to share data. For instance, in the Minneapolis/St. Paul, Minn. metropolitan area, the major real estate listing agencies have agreed to share listing information with each other. Each agency is then responsible for making the combined information available on their own web sites. This can presently be seen at the web sites found at www.edina.com and www.cbburnet.com.

The problem with this solution is that small agencies can be excluded from the deals. Even if they are included, they may be unable to afford the programming and server power to handle a constantly updated pool of data. In addition, some businesses are reluctant to include data from competing business on their web site, since it might drive traffic to their competitors.

What is needed is a technique to allow data from competing businesses to be shared and aggregated in such a way that they can be utilized at the web site of each of the competing businesses. Ideally, the aggregated data could be easily integrated into an existing web site. In addition, what is needed is a way for business to selectively remove some of the identifying information from the aggregated data. In this way, customers searching the aggregated data on a particular web site would need to contact the business that hosted the web site to obtain more information about the found data, rather than directly contacting the competitor that originated that data.

### SUMMARY OF THE INVENTION

The present invention provides a method and system for delivering data items via a network data sharing system. Individual businesses have computer systems in which these businesses store data about products, listings, or services available through that business. This data is then transmitted to a central server system, which then aggregates similar data from multiple businesses into a single database.

Each business operates its own web site for the benefit of its end users. These web sites provide access to the aggregated data maintained by the central server system. In addition, each business can use their own web site to develop brand name recognition and to promote additional services provided by the business itself or by partner businesses.

The central server system provides each web site with access to the aggregated data. This is accomplished by providing the web sites with HTML data that contains a portion of the aggregated data. It is possible to remove identifying information from the provided HTML data so as to limit the end users ability to use the data without assistance from the business providing the web site. The HTML data will preferably contain search, selection, and sorting functions that gives the end user the ability to control the content and order of the aggregated data presented. The HTML data can either be shown as a separate frame forming a part of the client system's web site, or is otherwise integrated into an HTML page created by the client system. When the server system receives a sorting, searching, or selection request from an end user, the server system applies the request to all of, or a relevant portion of, the aggregated data. The revised data is then returned, either to the client system for integration in a new web page, or directly to the end user as an HTML page for the appropriate frame.

### BRIEF DESCRIPTION OF THE DRAWINGS

FIG. 1 is a conceptual diagram of the present invention server system seen in its useable environment.

FIG. 2 is a conceptual view of an example web page utilizing the present invention.

### DETAILED DESCRIPTION OF THE INVENTION

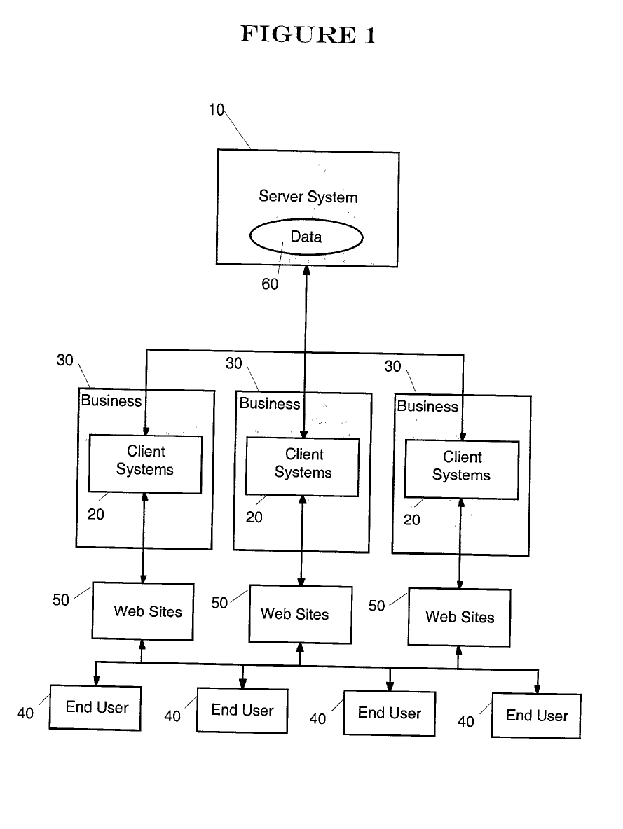

The present invention provides a method and system for delivering and receiving data items in a client/server network environment, as shown in FIG. 1. As seen in this Figure, the server system 10 is affiliated with numerous client systems 20. Each of the client systems 20 is operated by a business 30. In most cases, each of the businesses 30 competes directly with one another in the same business area. End users 40 access the web sites 50 that are provided by the client systems 20 of the businesses 30.

Each of the businesses 30 develops data related to property, products, or services that are available through the business 30. End users 40 traditionally access such information directly from the web sites 50 of the businesses 30. While there may be some overlap in the property, products, or services provided by the businesses 30, in many cases end users 40 will be interested in shopping at multiple businesses 30 before making a purchase. For example, if the businesses 30 are real estate agencies, the businesses 30 develop data in the form of property listings that are being handled by the business 30. End users 40 shopping for real estate will likely be interested in examining information from multiple real estate agencies 30. To do so, end users 40 would traditionally be forced to examine the web sites 50 of all of the local businesses 30 handling real estate listings.

The server system 10 is able to aggregate the data developed by the separate businesses 30 into a single, searchable collection of data 60. The server 10 accomplishes this by assigning a unique client identifier to each of the client systems 20. Client systems 20 are then programmed to send new and updated data records to the server system 10, which then modifies the data collection 60 appropriately.

Using this data collection 60, the web sites 50 are each able to present information to the end users 40 about the data collected by all of the businesses 30. Ideally, the server system 10 sends information from the collected data 60 to the client systems 20 in the form of HTML documents.

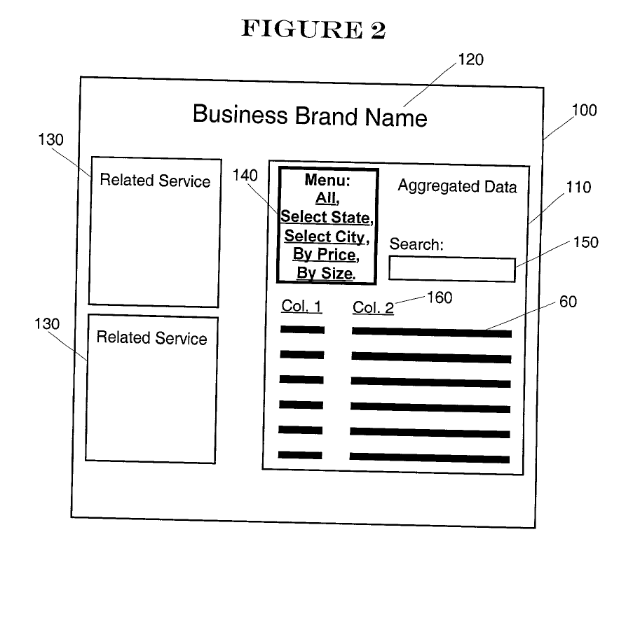

When the HTML formatted document is received by a client system 20, the client system 20 presents the received information by integrating the HTML document into a portion of its web site 50. This is seen in the sample web page 100 shown in FIG. 2. As can be seen in this Figure, an area 110 of the web page 100 is used to present a portion of the aggregated data 60. By presenting the data on the web site 50 of each business 30, the business 30 can prominently display its brand name 120 on its web pages 100. The business 30 can also position the display 110 of the aggregated data 60 next to descriptions of and advertisements for related goods or services 130. This can help the business 30 develop additional sources of revenue though the provision of such services or through referral fees from the service provider.

The integration of the aggregated data 60 with the web page 100 of a business 30 can be accomplished by taking the HTML information created by server system 10 and creating a new HTML page 100 around such information. For example, the HTML information can be placed within a cell of an HTML table. In this way, the HTML information is consistently placed in the same position 110 on each dynamically created page 100 in the web site 50. Alternatively, the HTML information can be combined with other information in the form of HTML frames. In this way, the HTML information received from the server system 10 is simply used as a single frame element 110 in a multi-frame web page 100 created for the web sites 50. Either way, the provision of data in HTML format allows the data to be preformatted by the server system 10 before being received by a client system 20. This allows a more streamlined and less complex client system 20 to be utilized to present the web site 50, since the handling of database formatting and queries can be handled directly by the server system 10 and need not be handled by the client system 20.

The HTML information received from server system 10 will almost always contain less than all of the information stored in the aggregated data 60. This subset of the aggregated data 60 can be selected through a variety of means, such as a hierarchical menu system 140 that adds structure to and divides the aggregated data. Alternatively, the subset of data 60 can be selected through searching mechanisms 150 that are well known in the art of database and web site creation. Finally, the subset of data usually can be sorted by the end user 40 so that the data is presented in a way that is most useful to the end user 40. The mechanism for sorting the data can take any form that is known in the prior art, such as an interface mechanism using links on column headers 160 to request that the data be sorted by the data in that column.

The mechanisms to select 140, search 150, or sort 160 data are preferably included in the HTML data provided by the server system 10 to the client systems 20. In this way, the end user 40 can interact with the server system 10 through the actual mechanisms provided by the server system 10. For instance, the end user 40 could choose a selection, search, or sort function through the mechanisms 140, 150, 160 that are found in the data portion 110 of the web page 100. This end user request can be sent by the client system 20 to the server system 10 after the request for the function is received from the end user 40 through the web site 50. Alternatively, if frames are used to present aggregated data 60 to the end user 40, the frame 110 containing the subset of the aggregated data 60 can send the function request directly from the browser used by the end user 40 to the server system 10. The server system 10 receives the request and applies the request to all of, or a relevant portion of, the aggregated data 60. The revised data is then returned, either to the client system 20 for integration in a new web page 100 on the web site 50, or directly to the end user 40 as an HTML page for the appropriate frame 110.

It is possible to remove information in the aggregated data 60 so as to limit the ability of end users 40 to use the data 60 without assistance from the participating businesses 30. For instance, in the real estate market, data from competing real estate agencies 30 can be aggregated for presentation to end users 40. Users 40 of each of the agencies' web sites 50 can access data from all of the agencies 30 on any one of the web sites 50. The present invention could remove various identification data, such as property location, or listing agent, from the data 60 before it is viewed by end users 40. This information would be available to the agencies 30 themselves. Thus, users 40 would have to contact the agency 30 that operates the web site 50 to obtain additional information about any property found in the aggregated data 60. This would be true even if the agency 30 that operates the particular web site 50 used by end user 40 was not the agency 30 that originally listed that property.

It is to be understood that the above description is intended to be illustrative, and not restrictive. Modifications and variations may be made to this description without departing from the spirit or scope of the invention. For example, the above description discusses the use of the present invention in the context of real estate listings. The same invention could be used to aggregate and present data among competing businesses in numerous types of business areas, such as new or used car listings, insurance policy quotations, airline or other types tickets, rental listings, medical product and information services, intra-industry data and product exchanges, online data, video delivery of movies, news, entertainment services, and the like. In addition, it is also possible to use a different language other than HTML to present the data from the server system 10 to the client systems 20. Alternative languages would include different “mark-up” languages such as XML, as well as any other structured language that would allow data to be easily received and incorporated by client systems 20. Consequently, the scope of the invention should be determined solely with reference to the appended claims, along with the full scope of equivalents to which such claims are entitled.

What is claimed is:

1. A method for aggregating and displaying data developed by competing business comprising:
a) collecting data at a client system of the competing businesses;
b) presenting the collected data to a server system;
c) aggregating the data from the at least two businesses into an aggregated data collection;
d) presenting a portion of the aggregated data collection to each business in the form of HTML data, the HTML data containing mechanisms to select, search, and sort the portion of the aggregated data; and
e) integrating the HTML data containing the aggregated data into web sites operated by or for the competing businesses without the need to alter the HTML data.

2. The method of claim 1, wherein the HTML data is integrated into the web sites by placing the HTML data within its own HTML frame.

3. The method of claim 1, wherein the HTML data is integrated into the web sites by placing the HTML data within a cell of an HTML table.
